(19) United States
(12) Patent Application Publication
(10) Pub. No.: US 2006/0107856 A1
(43) Pub. Date: May 25, 2006

(54) Printing-press arrangement

(75) Inventors: Andreas Muller, Plauen (DE); Ralph Schenderlein, Langenwetzendorf (DE); Erich Wagner, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/255,023

(22) Filed: Oct. 20, 2005

(30) Foreign Application Priority Data
Oct. 21, 2004 (DE) 10 2004 051 263.9

(51) Int. Cl. B41F 5/02

(52) U.S. Cl. 101/231

(57) ABSTRACT

An arrangement includes at least two web-fed rotary presses, wherein each of the at least two web-fed rotary presses includes a roll-changer unit with a plurality of roll changers, a printing unit with a plurality of press-unit towers, a turner-bar unit with a plurality of turner bars, and a folder unit with at least one folder superstructure and at least one folding unit. The units are arranged one behind the other in the axial direction of the respective web-fed rotary press. The web-fed rotary presses are arranged at a minimum axial distance from one another, and at least two of the roll changers of each of the roll-changer units are positioned above one another.

### BACKGROUND OF THE INVENTION

The invention relates to an arrangement comprising at least two web-fed rotary presses, wherein each web-fed rotary press includes a roll-changer unit with a plurality of roll changers, a printing unit with a plurality of press-unit towers, a turner-bar unit with a plurality of turner bars, and a folder unit with at least one folder superstructure and at least one folding unit, the above units being arranged one behind the other in the axial direction of the respective web-fed rotary press.

Web-fed rotary presses are constructed from a plurality of units, including a roll-changer unit, a printing unit, a turner-bar unit and a folder unit. The roll-changer unit comprises a plurality of roll changers and the printing unit comprises a plurality of press-unit towers, a plurality of press units being arranged within every press-unit tower. The turner-bar unit comprises a plurality of turner bars and the folder unit has at least one folder superstructure and at least one folding unit. In printing works, a plurality of web-fed rotary presses of this type are typically positioned in a works hall. Here, according to the prior art, the available building volume is not utilized in an optimum manner, with the result that efficiency losses are produced. This is caused, among other things, by the fact that the web-fed rotary presses are not optimized with regard to their installation space. Rather, it is customary to adapt the design or the configuration of a works hall to the web-fed rotary presses which are to be arranged in the the works hall, the result of which is a complex and complicated building design. This results in a different and individual arrangement of the web-fed rotary presses for every customer and in every building, as a result of which the mobility and flexibility is ultimately restricted for the customer. According to the prior art, it is thus as a rule not possible for the customer to move a printing-press arrangement identically from one works hall into another works hall. Rather, changeover work has to be carried out either on the web-fed rotary presses or on the works halls in the event of a move. As a result of the fact that, according to the prior art, the printing-press arrangements always differ from one another, no repetition effects are produced during the operation of the printing presses, with the result that operating personnel always have to be trained for a distinct printing-press arrangement. This also results ultimately in efficiency losses.

### SUMMARY OF THE INVENTION

An object of the present invention is to provide a novel arrangement comprising at least two web-fed rotary presses.

The object is met by an arrangement comprising at least two web-fed rotary presses in which the web-fed rotary presses are firstly arranged at a minimum axial distance from one another, and secondly at least two of the roll changers of each roll-changer unit are positioned above one another, to minimize the installation space of the printing press arrangement.

The dimensions of the printing-press arrangement in all three spatial dimensions and thus the installation space required by the said arrangement are minimized with the aid of the printing-press arrangement according to the present invention. The building volume of a works hall can thus be utilized in an optimum manner. Furthermore, the mobility is increased considerably for a customer, as the move into another works hall can be realized substantially more simply with the printing-press arrangement according to the invention than according to the prior art. It is possible to dispense with a complicated building design or one which is adapted to a specific printing-press arrangement. Printing centers with identical printing-press arrangements can be constructed with the printing-press arrangement according to the invention, with the result that repetition effects are ultimately also observed in operation. After a move, the operating personnel do not have to be trained again from the beginning for a specific printing-press arrangement. Operating personnel can be used flexibly in different printing centers which use the printing-press arrangement according to the present invention, without retraining expenditure.

The axial distance of the web-fed rotary presses is preferably adapted to the production of a common printed product such that, to ensure sectional flexibility of the printed product and/or page flexibility of the sections of the printed product, a printing material which has been printed and optionally pre-folded in the printing unit of a first web-fed rotary press can be fed entirely or partially to an adjacent, second web-fed rotary press.

According to an embodiment of the present invention, a printed, non-folded and accordingly web-shaped printing material can be fed entirely or partially from the turner-bar unit of the first web-fed rotary press to the turner-bar unit of the adjacent, second web-fed rotary press to ensure page flexibility of the sections of the printed product. A printed printing material which has been pre-folded in a folder superstructure of the folder unit of a first web-fed rotary press and is accordingly stream-shaped can be fed to a folding unit of the folder unit of an adjacent, second web-fed rotary press to ensure sectional flexibility of the printed product.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a side view of an arrangement according to the present invention comprising two web-fed rotary presses;

FIG. 2 is a plan view of the arrangement from FIG. 1, according to a first embodiment of the invention;

FIG. 3 is a section view of the arrangement comprising two web-fed rotary presses along line III-III according to FIG. 2 and FIG. 7;

FIG. 4 is a further section view of the arrangement comprising two web-fed rotary presses along line IV-IV according to FIG. 2 and FIG. 7;

FIG. 5 is a further section view of the arrangement comprising two web-fed rotary presses along line V-V according to FIG. 2 and FIG. 7;

FIG. 6 is a further section view of the arrangement comprising two web-fed rotary presses along line VI-VI according to FIG. 2;

FIG. 7 is a plan view of the arrangement from FIG. 1, according to a second embodiment of the present invention; and

FIG. 8 is a section view of the arrangement comprising two web-fed rotary presses along line VIII-VIII according to FIG. 7.

### DETAILED DESCRIPTION OF THE PRESENTLY PREFERRED EMBODIMENTS

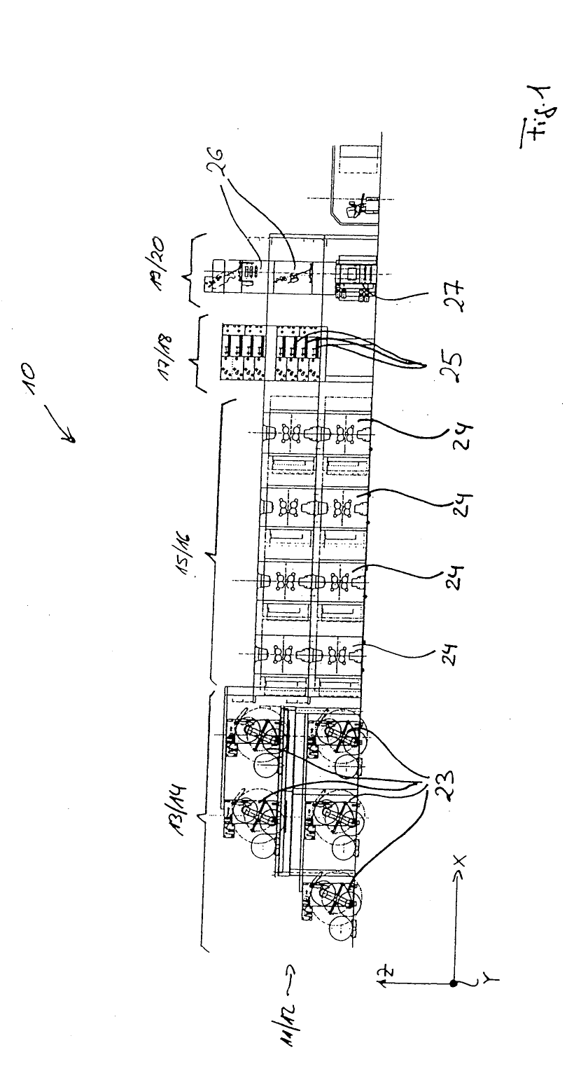

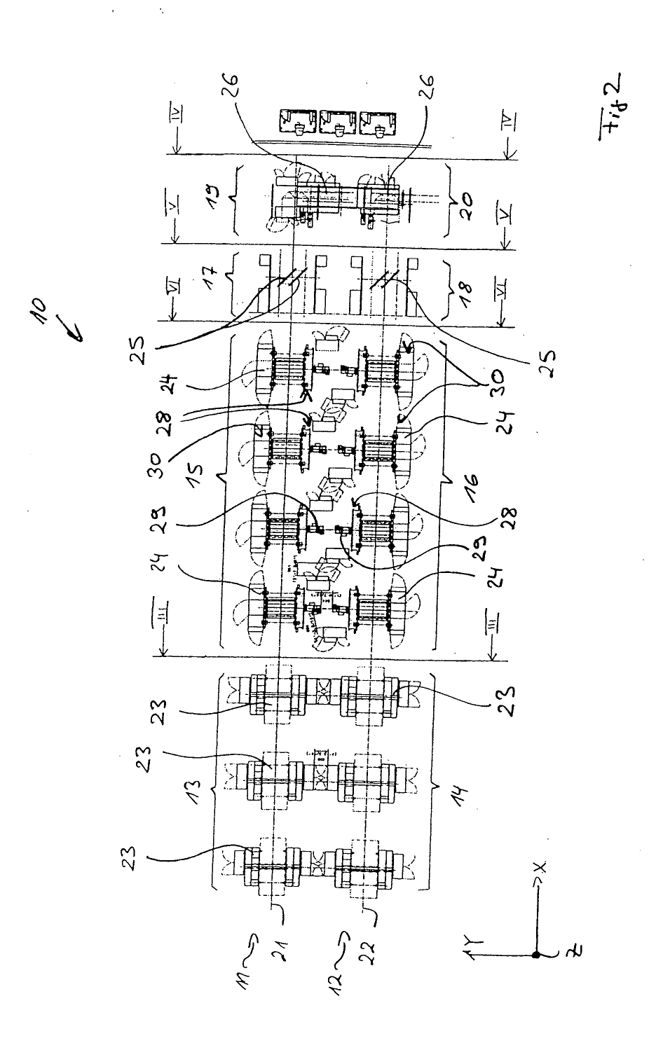

FIGS. 1 to 6 show a first exemplary embodiment of a printing-press arrangement 10 according to the invention, FIG. 1 showing a side view and FIG. 2 a plan view of the printing-press arrangement 10 according to the invention. In the exemplary embodiment shown, the printing-press arrangement 10 comprises two web-fed rotary presses 11 and 12, each of the two web-fed rotary presses 11 and 12 having a roll-changer unit 13 and 14, respectively, a printing unit 15 and 16, respectively, a turner-bar unit 17 and 18, respectively, and a folder unit 19 and 20, respectively. The above units are positioned one behind another in the axial direction of the respective web-fed rotary press 11 or 12, the axial direction being symbolized by the dashed lines 21 and 22.

It is to be noted at this point that one exemplary embodiment is described in the above text. It goes without saying that it is conceivable for it to be also possible for the units 13 or 14, 15 or 16, 17 or 18 and 19 or 20 to stand outside the arrangement 10 in the axial direction, that is to say, for example, the roll-changer unit 13 or 14 and/or the folder unit 19 or 20 at a 90° angle to one another.

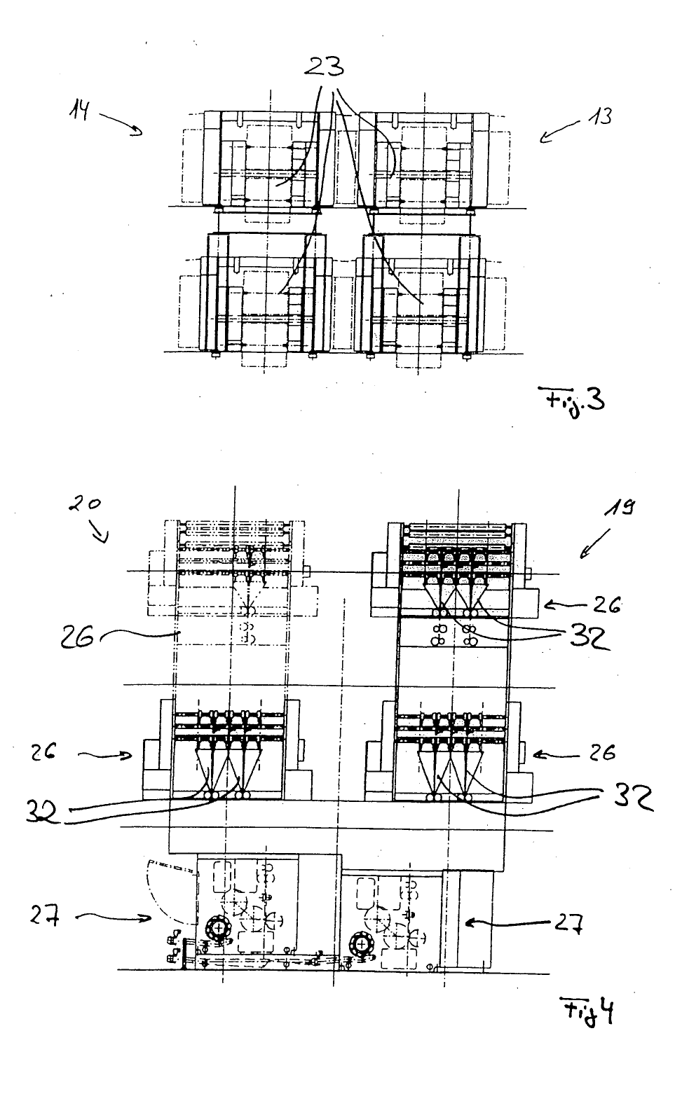

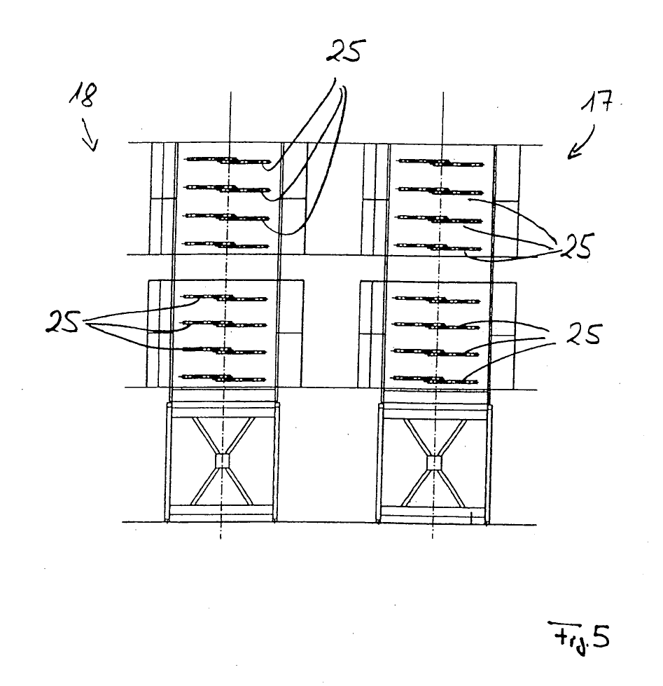

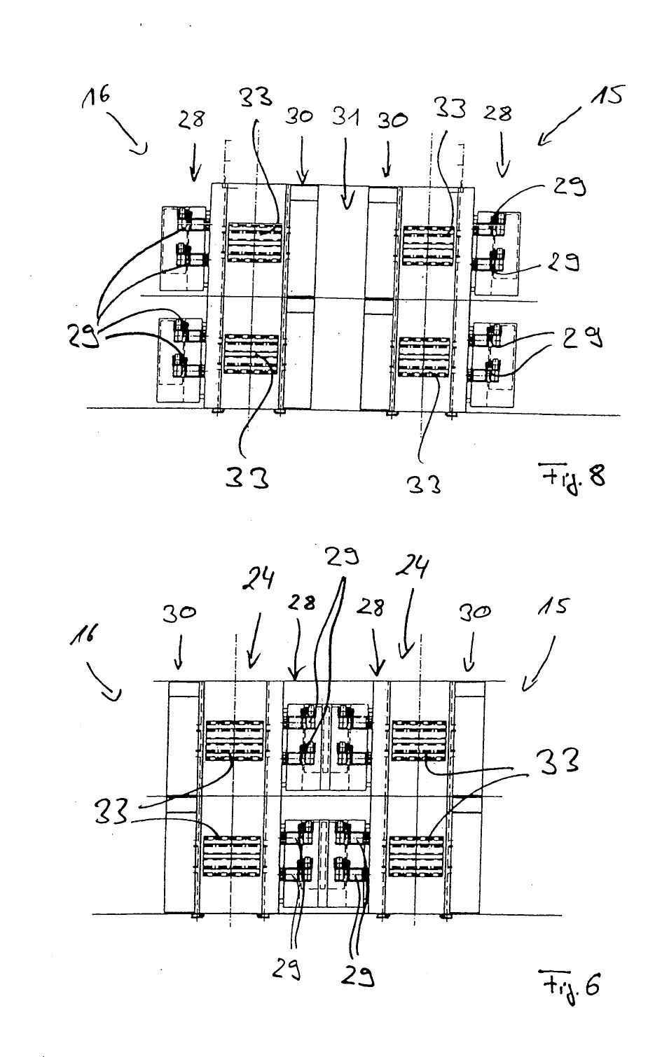

In the exemplary embodiment shown, each of the roll-changer units 13 and 14 comprises a total of five roll changers 23, and each of the printing units 15 and 16 comprises a total of four press-unit towers 24, a plurality of press units being integrated into each press-unit tower 24. The turner-bar units 17 and 18 have a plurality of turner bars 25, and the folder units 19 and 20 have in each case at least one folder superstructure 26 and at least one folding unit 27. FIG. 3 shows a detailed view of the roll-changer units 13 and 14, FIG. 4 shows a detailed view of the folder units 19 and 20, FIG. 5 shows a detailed view of the turner-bar units 17 and 18, and FIG. 6 shows a detailed view of the printing units 15 and 16 of the two web-fed rotary presses 11 and 12.

In the context of the printing-press arrangement 10 according to the invention, the two web-fed rotary presses 11 and 12 are arranged at a minimum axial distance from one another in order to minimize the installation space, and secondly at least two of the roll changers 23 of each roll-changer unit 13 and 14 are positioned above one another. The distance between the lines 21 and 22 and accordingly the extent of the printing-press arrangement 10 according to the invention in the Y direction (see system of coordinates in FIGS. 1 and 2) are minimized by a minimum axial distance being maintained between the adjacent web-fed rotary presses 11 and 12. The available installation space in the Z direction is utilized in an optimum manner and the installation space in the X direction is minimized by at least two roll changers 23 being arranged above one another. Accordingly, optimization of the installation space and minimization of the installation space can be realized with the aid of the printing-press arrangement 10 according to the invention. The distance between the lines 21 and 22 and thus the axial distance between the web-fed rotary presses 11 and 12 preferably lie in a region of 4.5 m.

It is also to be pointed out at this point that every arrangement of the units which have been described in the above text can also be carried out in two planes.

In the exemplary embodiment of FIGS. 1 to 6, in each case two of the five roll changers 23 which are assigned to a web-fed rotary press 11 or 12 are positioned above one another. It can be gathered from FIG. 1 that the overall height in the region of the roll-changer units 13 or 14 is adapted here to the overall height of the remaining units of the web-fed rotary press 11 or 12. It is to be pointed out at this point that it goes without saying that a larger or smaller number of roll changers 23 can be assigned to the respective printing press 11 or 12.

In the exemplary embodiment of FIGS. 1 to 6, the two web-fed rotary presses 11 and 12 are oriented parallel to one another, such that the drive sides 28 of the press-unit towers 24 of the printing units 15 and 16 of the two immediately adjacent web-fed rotary presses 11 and 12 face one another. The drives 29 of the press-unit towers 24 can be seen in FIG. 2 in the region of the drive sides 28. In contrast, the operating sides 30 face away from one another, so that a circumferential operating space is provided as a result for the printing-press arrangement 10 of FIG. 2.

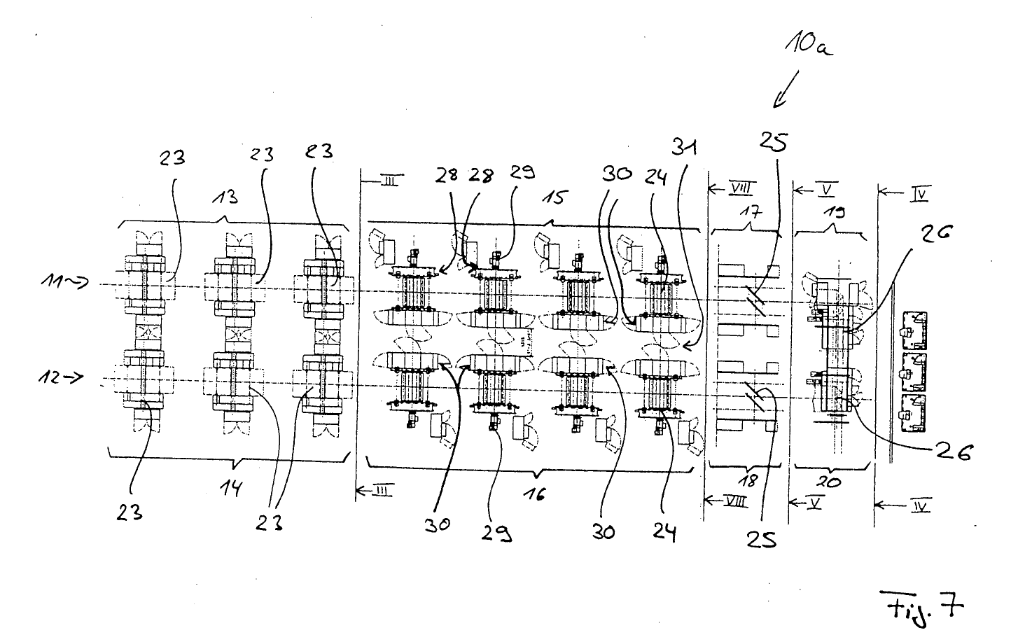

It is to be pointed out at this point that it goes without saying that the immediately adjacent web-fed rotary presses 11 and 12 can also be positioned with a different orientation to one another in the region of the printing units 15 and 16. FIG. 7 thus shows a printing-press arrangement 10a which differs from the printing-press arrangement 10 of FIG. 2 only in that the two web-fed rotary presses 11 and 12 are oriented parallel to one another, in such a way that the operating sides 30 of the press-unit towers 24 of the printing units 15 and 16 of the two web-fed rotary presses 11 and 12 lie opposite one another. As a result, a common operating space 31 is provided between the two web-fed rotary presses 11 and 12. Accordingly, in the embodiment of FIG. 7, the drive sides 28 of the press-unit towers 24 of the two printing units 15 and 16 face away from one another. As, however, the two printing-press arrangements 10 and 10a do not differ with regard to the remaining details, identical reference numerals are used here for identical assemblies to avoid unnecessary repetitions.

Although it is not shown in the figures, it is also possible for the two web-fed rotary presses 11 and 12 to be oriented with respect to one another in such a way that the drive side of the press-unit towers of the printing unit of a first web-fed rotary press lies opposite an operating side of the press-unit towers of the printing unit of a second web-fed rotary press. However, the arrangements of FIGS. 2 and 7 are preferred.

Furthermore, in the context of the present invention, it is proposed to adapt the axial distance of the web-fed rotary presses 11 and 12 of the printing-press arrangements 10 and 10a according to the invention to the production of a common printed product such that a printing material which has been printed and optionally pre-folded in the printing unit 15 or 16 of a first web-fed rotary press 11 or 12 can be fed entirely or partially to an adjacent, second web-fed rotary press 12 or 11, to ensure sectional flexibility of the printed product and/or page flexibility of the sections of the printed product. As a result, it becomes possible to branch off printed pages and/or sections from a web-fed rotary press and feed them to the adjacent web-fed rotary press. This considerably increases the flexibility of printed products which are to be produced.

For example, it is possible in the embodiments shown, to feed a printed, non-folded and accordingly web-shaped printing material entirely or partially from the turner-bar unit 18 of the web-fed rotary press 12 to the turner-bar unit 17 of the adjacent web-fed rotary press 11, to ensure page flexibility of the sections of the printed product to be produced. For this purpose, the printed and web-shaped printing material is deflected by 90° at a turner bar 25 of the turner-bar unit 18 of the web-fed rotary press 12, fed with this deflection to the turner-bar unit 17 of the adjacent web-fed rotary press 11, and deflected again by 90° in the region of this turner-bar unit 17 at a further turner bar 25, so that the branched-off printing material then again runs in the direction of the axial direction of the corresponding printing press. The printed pages which are printed on the web-fed rotary press 12 can accordingly be fed entirely or partially to the adjacent web-fed rotary press 11, in order to make the page number variable of the sections which are to be produced there.

Furthermore, it lies within the scope of the present invention to feed a printed printing material which has been pre-folded in a folder superstructure 26 of the folder unit 19 or 20 of a first web-fed rotary press 11 or 12 and is accordingly stream-shaped to a folding unit 27 of the folder unit 20 or 19 of the adjacent web-fed rotary press 12 or 11, to ensure sectional flexibility of a printed product which is to be produced. Thus, for example, a stream-shaped printing material which has been pre-folded in the folding unit 27 of the folder unit 20 of the web-fed rotary press 12 can be fed to the folding unit 27 of the folder unit 19 of the adjacent web-fed rotary press 11 after it has left the corresponding folder superstructure 26. In the embodiment of FIG. 4, two folder superstructures 26 with in each case two folding formers 32 are positioned above one another in the region of the folder unit 19 of the web-fed rotary press 11, whereas there is only one folder superstructure 26 with two folding formers 32 in the region of the folder unit 20 of the web-fed rotary press 12. The folder superstructure (shown by a dashed line in FIG. 4) in the region of the folder unit 20 shows that a further folder superstructure 26 can also be arranged in the region of the folder unit 20.

Accordingly, the printing-press arrangement 10 or 10a according to the invention permits the exchange of printed pages or sections between adjacent web-fed rotary presses and accordingly increases the flexibility during the production of a printed product.

The web-fed rotary presses which are to be positioned next to one another of the printing-press arrangements 10 and 10a according to the invention can be of either identical or different configuration. Web-fed rotary presses of different configuration differ, in particular, with regard to the number of printed pages which can be printed on the web-fed rotary presses. It is thus possible, for example, to position web-fed rotary presses within the printing-press arrangements 10 and 10a according to the invention, the press units of the press-unit towers 24 of the web-fed rotary presses being of different configuration such that a different number of printed pages can be printed in the circumferential direction and/or in the longitudinal direction of the corresponding impression cylinders 33. It is possible, for example, to print four printed pages in the longitudinal direction or axial direction of the impression cylinder 33 and in each case one printed page in the circumferential direction on the impression cylinders 33 of the printing unit 15 of the web-fed rotary press 11, whereas two printed pages can be printed next to one another in the longitudinal direction and in each case one printed page can be printed behind one another in the circumferential direction on the impression cylinders 33 of the printing unit 16 of the web-fed rotary press 12. The number of printed pages which can be printed on the web-fed rotary presses in the circumferential direction and longitudinal direction can accordingly vary between the individual web-fed rotary presses or else be identical.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An arrangement comprising at least two web-fed rotary presses, wherein each of said at least two web-fed rotary presses includes a roll-changer unit with a plurality of roll changers, a printing unit with a plurality of press-unit towers, a turner-bar unit with a plurality of turner bars, and a folder unit with at least one folder superstructure and at least one folding unit, said roll changer units, printing units, turner-bar units, and folder units being arranged one behind the other in an axial direction of the respective web-fed rotary press, wherein said at least two web-fed rotary presses are arranged at a minimum axial distance from one another and at least two of said roll changers of each of said roll-changer units are positioned above one another.

2. The arrangement of claim 1, wherein two immediately adjacent web-fed rotary presses of said at least two web-fed rotary presses are oriented substantially parallel to one another such that operating sides of said press-unit towers of said printing units of said two web-fed rotary presses lie opposite one another, thereby defining a common operating space therebetween.

3. The arrangement of claim 1, wherein two immediately adjacent web-fed rotary presses of said at least two web-fed rotary presses are oriented substantially parallel to one another such that drive sides of said press-unit towers of said printing units of said two web-fed rotary presses lie opposite one another, thereby providing a circumferential operating space around said printing units of said two web-fed rotary presses.

4. The arrangement of claim 1, wherein two immediately adjacent web-fed rotary presses of said at least two web-fed rotary presses are oriented substantially parallel to one another such that a drive side of said press-unit towers of said printing unit of a first one of said two web-fed rotary presses lies opposite an operating side of said press-unit towers of said printing unit of a second one of said two web-fed rotary presses.

5. The arrangement of claim 1, wherein the axial distance between said web-fed rotary presses is adapted to a production of a common printed product such that a printing material which has been printed and optionally pre-folded in said printing unit of a first one of said at least two web-fed rotary presses is fed entirely or partially to an adjacent second one of said at least two web-fed rotary presses, thereby ensuring sectional flexibility of the printed product or page flexibility of the sections of the printed product.

6. The arrangement of claim 5, wherein a printed, non-folded and accordingly web-shaped printing material is fed entirely or partially from a turner-bar unit of a first one of said at least two web-fed rotary presses to a turner-bar unit of an adjacent second one of said at least two web-fed rotary presses, thereby ensuring page flexibility of the sections of the printed product.

7. The arrangement of claim 5, wherein a printed printing material which has been pre-folded in a folder superstructure of said folder unit of said first one of said at least two web-fed rotary press and is accordingly stream-shaped is fed to a folding unit of said folder unit of said adjacent second one of said at least two web-fed rotary presses, thereby ensuring sectional flexibility of the printed product.

8. The arrangement of claim 1, wherein two immediately adjacent ones of said at least two web-fed rotary presses are configured identically such that web-shaped printing materials are printed with an identical number of printed pages in each of said adjacent ones of said at least two web-fed rotary presses.

9. The arrangement of claim 1, wherein two immediately adjacent ones of said at least two web-fed rotary presses are configured differently such that web-shaped printing materials are printed with a different number of printed pages in each of said adjacent ones of said at least two web-fed rotary presses.

10. The arrangement of claim 9, wherein press units of said press-unit towers of said adjacent ones of said at least two web-fed rotary presses are configured differently such that a different number of printed pages is printed in the circumferential direction or in the longitudinal direction of corresponding impression cylinders.
